(19) United States
(12) Patent Application Publication
(10) Pub. No.: US 2008/0145179 A1
(43) Pub. Date: Jun. 19, 2008

(54) Sleeve

(75) Inventors: Erich AMANN, Rottenburg (DE); Peter BOHRINGER, Hulben (DE)

Correspondence Address: Edward J. Timmer, P.O. Box 770, Richland, MI, 49083, US

(73) Assignee: ElringKlinger AG

(21) Appl. No.: 11/973,516

(22) Filed: Oct. 9, 2007

Related U.S. Application Data
(63) Continuation of application No. PCT/EP06/10071, filed on Oct. 19, 2006.

(51) Int. Cl. F16B 39/26; F16B 29/00; B21D 53/20; F16B 43/00; F16B 35/00

(52) U.S. Cl. 411/378; 411/531; 470/41

(57) ABSTRACT

In order to provide a sleeve comprising a sleeve base body and a flange that is produced separately from the sleeve base body and protrudes in the radial direction beyond the sleeve base body, which is producible in a simple manner but nevertheless ensures secure retention of the sleeve base body and the flange, it is proposed that the sleeve base body comprise at least one projection which engages in a recess provided in the flange, wherein the sleeve base body is pressed against the flange in such a manner that the sleeve base body and the flange are connected together in captive manner.

### RELATED APPLICATION

The present disclosure relates to the subject-matter which was disclosed in the international patent application No. PCT/EP2006/010071 dated Oct. 19, 2006. The entire description of this earlier application is incorporated by reference thereto as a constituent part of the present description (“incorporation by reference”).

### FIELD OF DISCLOSURE

The present invention relates to a sleeve comprising a sleeve base body and a flange which is produced separately from the sleeve base body and protrudes in the radial direction beyond the sleeve base body.

### BACKGROUND

Such a sleeve is known from DE 199 24 502 C2. In this known sleeve, the sleeve base body is fixed to the flange by an adhered, welded or soldered joint. The flange and/or the sleeve base body are slit so that the sleeve base body and/or the flange expand when slipping the narrow section formed by the flange over the threaded portion of a screw member and then snap back again after the narrow section has been pushed completely over the threaded portion. The sleeve is held captive on the screw member once it has snapped back.

A further sleeve consisting of a flange and a sleeve base body both of which are held captive on the screw member is known from DE 195 10 349 A1. In this sleeve, the flange has a punched opening having a collar which is surrounded by the sleeve base body in clamping manner. For the purposes of clamping the collar of the flange, the inside of the sleeve base body must be provided with a chamfer at the screw member head end thereof. The retention of the sleeve base body on the flange, which is only effected by the clamping effect of the collar projecting into the sleeve base body, is not particularly secure.

### SUMMARY OF THE INVENTION

The object of the present invention is to provide a sleeve of the type mentioned hereinabove which is producible in a simple manner but which nevertheless ensures that the sleeve base body and the flange are held securely together.

In accordance with the invention, this object is achieved in the case of a sleeve comprising the features indicated in the preamble of claim 1 in that the sleeve base body has at least one projection which engages in a recess provided in the flange, wherein the sleeve base body is pressed against the flange in such a manner that the sleeve base body and the flange are connected together in captive manner.

Thus, the concept underlying the present invention is that of interlocking the sleeve base body and the flange by the projection of the sleeve base body and the recess in the flange and also by the process of pressing the sleeve base body and the flange together in such a manner that the sleeve base body is securely fixed to the flange.

In a preferred embodiment of the invention, provision is made for the sleeve base body to have at least two projections which engage in a respective recess provided in the flange.

The hold between the sleeve base body and the flange pressed thereto is thereby improved.

A further improvement in the hold between the flange and the sleeve base body is obtained if the sleeve base body has at least three projections which engage in a respective recess provided in the flange.

Preferably, the projections succeed one another substantially equidistantly around the periphery of the sleeve base body.

The at least one projection of the sleeve base body is preferably aligned substantially parallel to the longitudinal axis of the sleeve base body.

In order to enable the flange to rest on the screw member head of a screw member which extends through the sleeve, it is of advantage if the at least one projection is arranged at the screw member head end of the sleeve base body.

In a preferred embodiment of the invention provision is made for the regions of the flange bounding the at least one recess which may, in particular, be in the form of webs to be oriented substantially perpendicularly to the longitudinal axis of the sleeve base body in the state where it is pressed against the sleeve base body. The effect thereby achieved is that the flange is substantially flat in the state where it is pressed against the sleeve base body.

The at least one recess in the flange preferably opens into a passage opening in the flange.

The flange preferably incorporates a passage opening arranged substantially centrally of the flange, in particular, a passage opening for the passage of a screw member through the sleeve.

In a preferred embodiment of the invention, the flange is formed from a flange pre-form wherein the regions of the flange bounding the at least one recess in the flange which may, in particular, be in the form of webs are oriented at an angle with respect to the central axis of the flange.

In particular hereby, provision may be made for the regions of the flange pre-form bounding the at least one recess in the flange to define a passage opening in the pre-form the diameter is of which greater than the diameter of the passage opening in the flange when in the state where it is pressed against the sleeve base body.

The flange of the sleeve in accordance with the invention can protrude radially inwardly and, at the same time, radially outwardly beyond the sleeve base body.

As an alternative thereto, provision could also be made for the flange to protrude only radially outwardly beyond the sleeve base body.

In this case in particular, the radially inner edge of the flange can be flush with an inner wall of the sleeve base body.

The sleeve in accordance with the invention is suitable in particular for use in a combination of a sleeve in accordance with the invention and a screw member which passes through the sleeve.

In a preferred embodiment of such a combination, provision is made for the sleeve to be held captive on the screw member.

Preferably, the process of pressing the sleeve base body and the flange together is only carried out when the screw member has been inserted into the sleeve base body and a flange pre-form so that it is not necessary to use a slit sleeve base body and/or a slit flange, but rather, a slit-free sleeve base body and a slit-free flange can be used.

If the screw member comprises a screw member head, a threaded portion and a shank portion which is arranged between the screw member head and the threaded portion and has an external diameter that is smaller than the external diameter of the threaded portion, then by means of this in particular, the sleeve can be held captive on the screw member in that the flange incorporates a passage opening the diameter of which is smaller than the external diameter of the threaded portion of the screw member.

Preferably provision is made for the flange of the sleeve to be formed from a flange pre-form incorporating a passage opening in the pre-form the diameter of which is so large that the threaded portion of the screw member is movable through the passage opening in the pre-form.

By means of this, it becomes possible to join the flange pre-form and the sleeve base body together in such a way that the at least one projection of the sleeve base body engages in the at least one recess in the flange pre-form, thereafter to move the threaded portion of the screw member through the passage opening in the pre-form and then to press the sleeve base body against the flange pre-form in such a way that the sleeve base body and the flange formed from the flange pre-form by the pressing process are connected together to form the sleeve and are held captive on the screw member.

Furthermore, the present invention relates to a method of making a sleeve consisting of a sleeve base body and a flange which protrudes in the radial direction beyond the sleeve base body.

The further object of the present invention is to provide a method of producing such a sleeve which can be carried out in a simple manner and leads to the sleeve base body and the flange being securely held together. In accordance with the invention, this object is achieved by a method which comprises the following method steps:
providing a flange pre-form incorporating a passage opening in the pre-form and at least one recess;
providing a sleeve base body having at least one projection;
arranging the sleeve base body on the flange pre-form in such a manner that the at least one projection of the sleeve base body engages in the at least one recess in the flange pre-form;
pressing the sleeve base body against the flange pre-form in such a manner that the flange pre-form is deformed into a flange which is connected to the sleeve base body in captive manner.

Further features and advantages of the invention form the subject matter of the following description and the graphical illustration of an exemplary embodiment.

### BRIEF DESCRIPTION OF THE DRAWINGS

FIG. 1 shows a schematic vertical sectional view through an assembly consisting of a first component and a second component which are fixed together by means of a screw member having a sleeve that is held captive on the screw member and are also decoupled from vibration by means of elastomer elements;

FIG. 2 a schematic longitudinal sectional view through the screw member with a washer and an elastomer element depicted in FIG. 1;

FIG. 3 a plan view from above of the screw member with the sleeve and the elastomer element depicted in FIG. 2;

FIG. 4 a schematic exploded illustration of the screw member, a flange pre-form, a sleeve base body and the elastomer element before the assembly of these elements,

FIG. 5 a schematic plan view from above of the flange pre-form depicted in FIG. 4;

FIG. 6 a schematic longitudinal sectional view through the flange pre-form when joined to the sleeve base body;

FIG. 7 a schematic perspective illustration of the flange and the sleeve base body after the flange and the sleeve base body have been pressed together; and

FIG. 8 a schematic vertical section through an assembly consisting of a first component and a second component which are fixed together by means of a screw member, a sleeve and an elastomer element, wherein a passage opening in a flange of the sleeve has a diameter which is greater than the external diameter of the threaded portion of the screw member.

Similar or functionally equivalent elements are designated by the same reference symbols in each of the Figures.

### DETAILED DESCRIPTION OF THE INVENTION

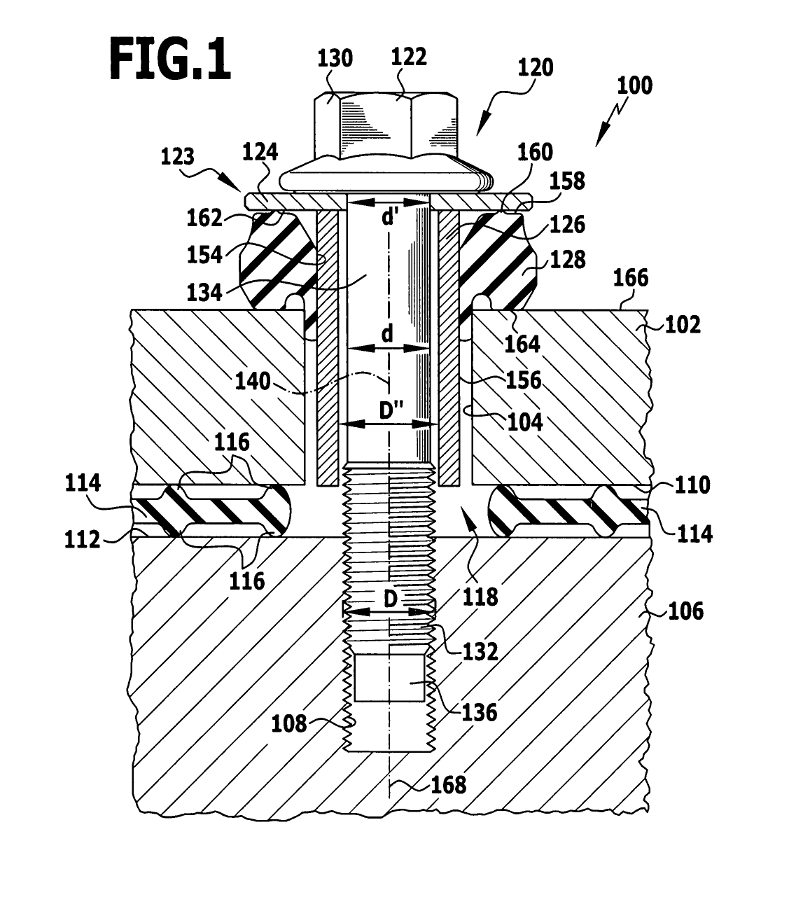

An assembly bearing the general reference 100 which is illustrated in sectional manner in FIG. 1 comprises a first component 102 having a substantially cylindrical passage opening 104, a second component 106 having a threaded blind hole 108, an elastomer sealing element 114 comprising sealing lips 116 which is arranged between a lower surface 110 of the first component 102 and an upper surface 112 of the second component 106 and incorporates a passage opening 118 in the vicinity of the threaded blind hole 108, and also a combination 120 consisting of a screw member 122, a sleeve 123 which is held captive on the screw member 122 and comprises a flange 124 and a hollow cylindrical sleeve base body 126, and, a ring-shaped element 128 surrounding the screw-head-end end portion of the sleeve base body 126 in ring-like manner.

The screw member 122 comprises a screw member head 130 which may be in the form of a hexagonal screw member head for example, a threaded portion 132 having an external diameter D, a shank portion 134 which is arranged between the threaded portion 132 and the screw member head 130 and has an external diameter d that is smaller than the external diameter D of the threaded portion, and an end portion 136 which adjoins the end of the threaded portion 132 remote from the screw member head 130 and has an external diameter that is smaller than the external diameter D of the threaded portion 132 and smaller than the external diameter d of the shank portion 134 of the screw member 122.

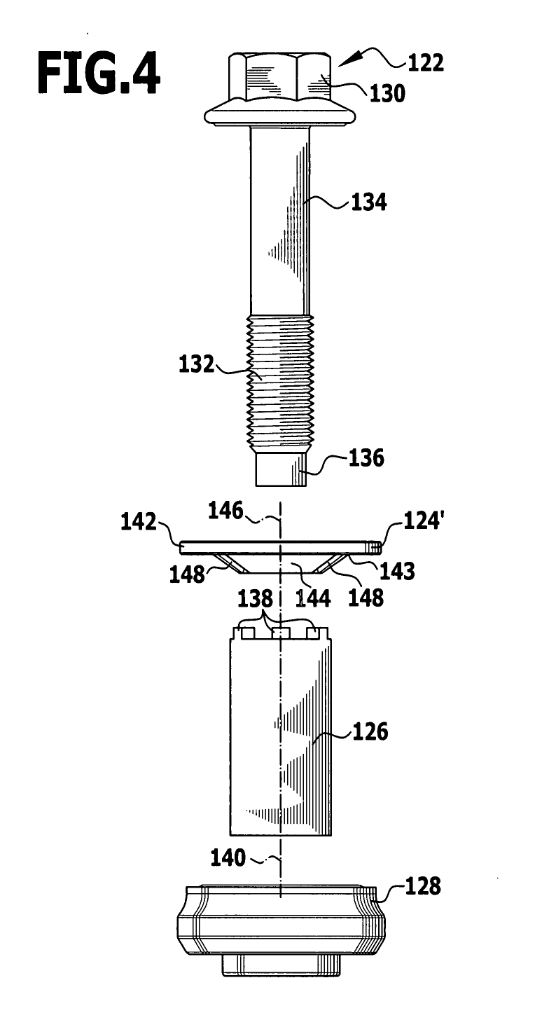

As can best be seen from FIG. 4, the sleeve base body 126 is of hollow cylindrical shape and is provided at the screw member head end thereof with a plurality of, three for example, projections 138 which extend in parallel with the longitudinal axis 140 of the sleeve base body 126 and are spaced substantially equidistantly from one another around the periphery of the sleeve base body 126.

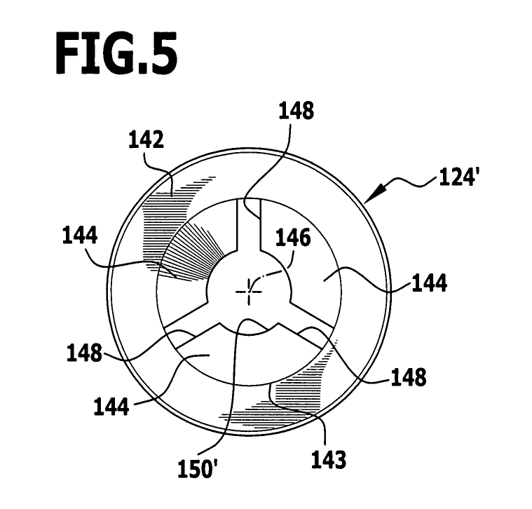

The flange 124 protruding radially inwardly and outwardly beyond the sleeve base body 126 is formed from a flange pre-form 124′ as is illustrated in FIGS. 4 and 5.

The flange pre-form 124′ comprises a flat ring-like region 142 from the radially inward edge 143 of which there project a plurality of, three for example, webs 144 which are directed radially inwardly and are inclined at an angle with respect to the central axis 146 of the flange pre-form 124′, preferably at an angle of approximately 30° to approximately 60° to the central axis 146. These webs 144 each extend over a substantially mutually equal peripheral angle, whereby the successive webs 144 are separated from one another around the periphery of the flange pre-form 124′ by a respective recess 148 running in the radial direction.

Each of the, three for example, recesses 148 opens into a substantially circular, central passage opening 150′ in the flange pre-form 124′.

In order to produce the flange 124 from the flange pre-form 124′ and at the same time connect the flange 124 and the sleeve base body 126 together in captive manner to form the sleeve 123 and to ensure that the sleeve 126 is securely captive on the screw member 122, one proceeds as follows:

The sleeve base body 126 is arranged on the flange pre-form 124′ in such a way that the longitudinal axis 140 of the sleeve base body 126 and the central axis 146 of the flange pre-form 124′ coincide and the projections 138 at the screw member head end of the sleeve base body 126 engage in a respective recess 148 of the flange pre-form 124′.

In order to make this possible, the extent of the projections 138 in the peripheral direction of the sleeve base body 126 is slightly smaller than the extent of the recesses 148 in the peripheral direction of the flange pre-form 124′.

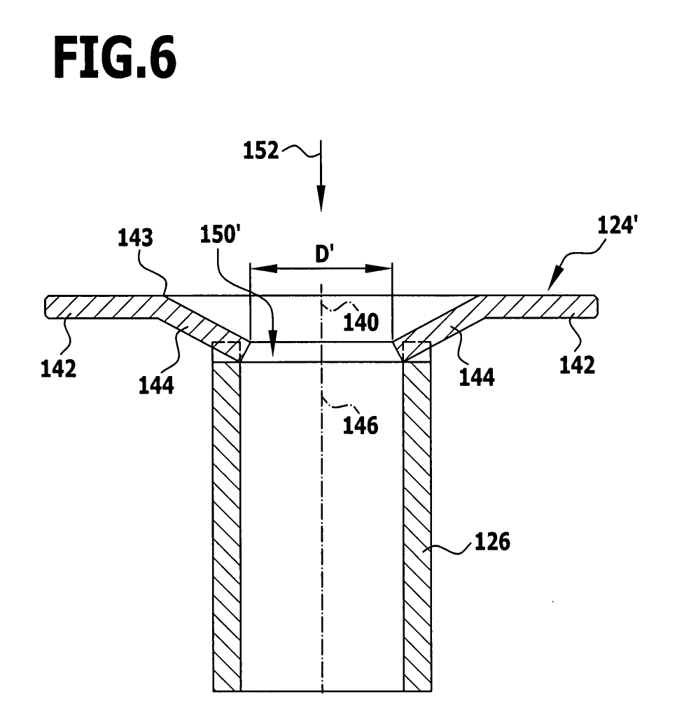

As a result of joining up the sleeve base body 126 and the flange pre-form 124′, there results an arrangement of a flange pre-form 124′ and a sleeve base body 126 such as is illustrated in the longitudinal sectional view of FIG. 6, wherein the central passage opening 150′ in the flange pre-form 124′ has a diameter D′ which is greater than the external diameter D of the threaded portion 132 of the screw member 122.

Consequently, the threaded portion 132 of the screw member 122 can be inserted forwardly in the direction of the arrow 152 in FIG. 6 into the flange pre-form 124′ and the sleeve base body 126 connected thereto, namely, in such a manner that the passage opening 150′ in the flange pre-form 124′ comes to rest around the shank portion 134 of the screw member 122.

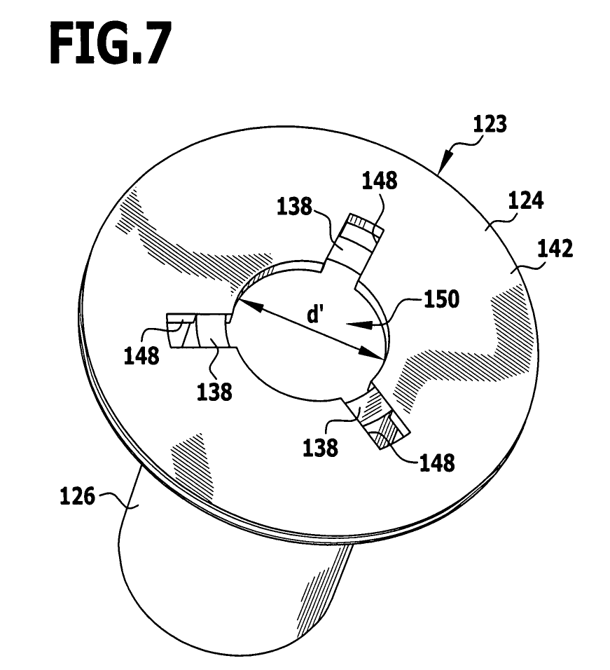

Subsequently, the sleeve base body 126 and the flange pre-form 124′ are pressed together in such a manner that the webs 144 are bent up into the plane of the flat ring-like region 142 of the flange pre-form 124′ and there then ensues the flange 124 (see FIG. 7) which is substantially flat and incorporates a passage opening 150 having a diameter d′ that is slightly greater than the external diameter d of the shank portion 134 of the screw member 122 and is smaller than the external diameter D of the threaded portion 132 of the screw member 122 so that, in the region of the passage opening 150 in the flange 124, there is formed a narrow section through which the threaded portion 132 of the screw member 122 can no longer be moved.

Thus, after the process of pressing the sleeve base body 126 onto the flange 124 by virtue of which the sleeve base body 126 and the flange 124 are connected to one another in positive and/or force-locking manner, the sleeve 123, i.e. the unit consisting of the sleeve base body 126 and the flange 124 is held captive on the screw member 122.

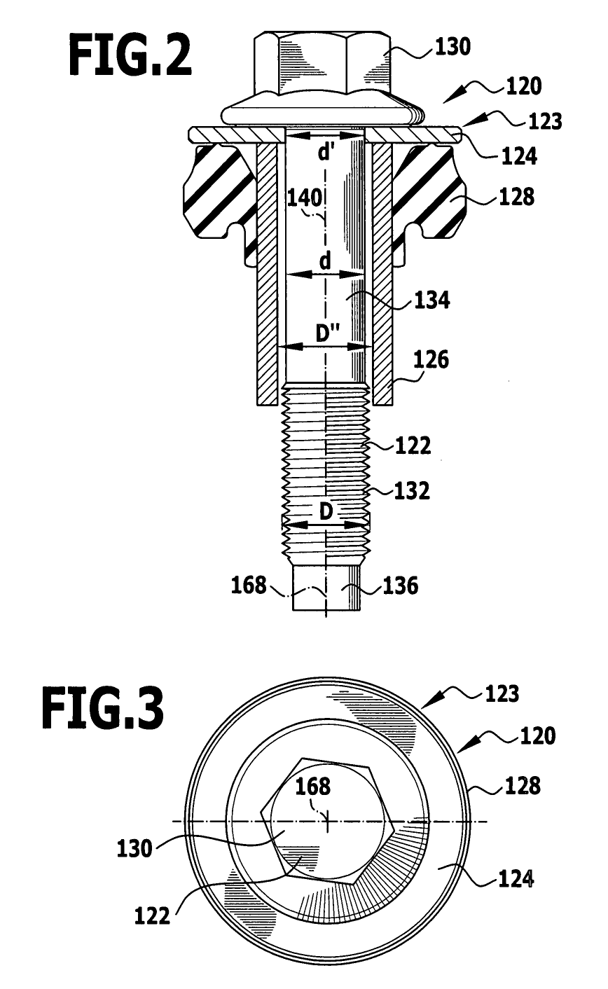

Thereafter, the ring-shaped element 128 which is preferably formed from a resilient material, from an elastomer material for example, is pushed onto the outer surface of the sleeve base body 126 (see FIGS. 2 and 3).

The sleeve base body 126, the flange 124 and the screw member 122 are preferably formed from a metallic material, and in particular from a steel material.

As can best be seen from FIG. 1, the ring-shaped element 128 has an inner contact surface 154 for application to the outer surface 156 of the sleeve base body 126, a screw member head contact surface 158 with a sealing lip 160 for application to the lower surface 162 of the flange 124, and a component contact surface 164 that is remote from the screw member head 130 for application to an upper surface 166 of the first component 102.

The ring-shaped element 128 may be pushed onto the outer surface 156 of the sleeve base body 126 in the form of a tight fit or it could also be a loose fit thereon.

In the installed state of the assembly 100 as is illustrated in FIG. 1, the external thread of the threaded portion 132 of the screw member 122 is rotated into the internal thread of the threaded blind hole 108 in the second component 106. The screw member 122 and the sleeve 123 extend through the passage opening 104 to the first component 102.

The sleeve 123 is supported on the first component 102 via the resilient ring-shaped element 128 so that the sleeve 123 and the screw member 122 are vibrationally-decoupled from the first component 102.

Furthermore, due to the elastomer sealing element 114 arranged between the first component 102 and the second component 106, there is provided a decoupling of vibrations between the two components 102 and 106.

In the assembled state wherein the upper surface of the flange 124 rests against the screw member head 130, the sleeve base body 126 extends downwardly into the region of the threaded portion 132 the external diameter D of which is only slightly smaller than the internal diameter D of the sleeve base body 126 so that it is ensured that the longitudinal axis 140 of the sleeve base body 126 and the sleeve 123 is aligned substantially parallel to the longitudinal axis 168 of the screw member 122.

The flange 124 of the sleeve 123 serves as a washer for the screw member 122.

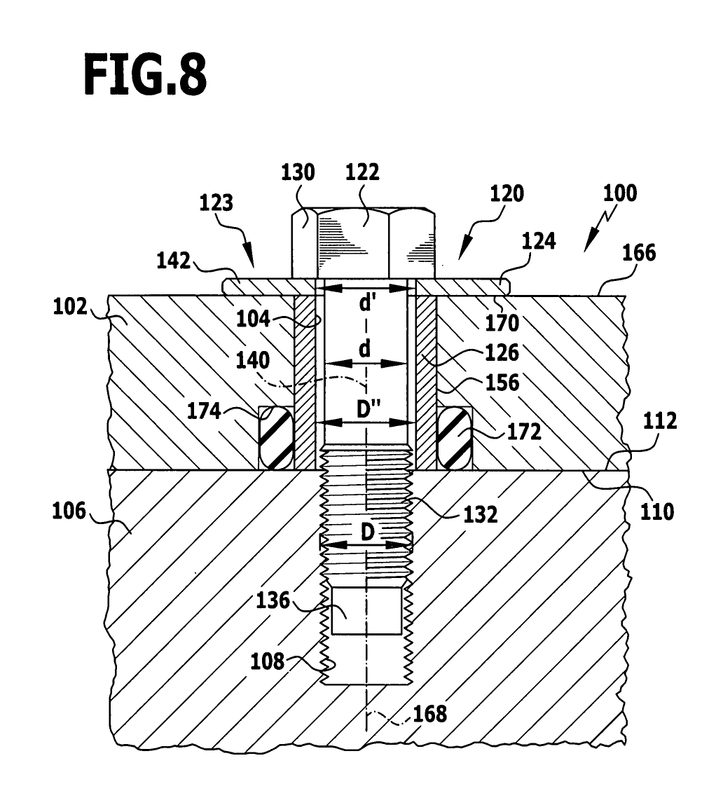

A second embodiment of an assembly 100 that is illustrated in sectional manner in FIG. 8 differs from the first embodiment of such an assembly which is illustrated in FIGS. 1 to 7 in that the sleeve 123 formed from the sleeve base body 126 and the flange 124 does not rest in vibrationally-decoupled manner on the first component 102 of the assembly 100 via a ring-shaped element 128, but rather, the lower surface 170 of the flange 124 rests directly on the upper surface 166 of the first component 102 and the outer surface 156 of the sleeve base body 126 rests directly on the boundary wall of the passage opening 104 in the first component 102.

Furthermore, the two components 102 and 106 of the assembly 100 are not spaced from one another in the axial direction of the screw member 122 by an elastomer sealing element 114; rather, the lower surface 110 of the first component 102 lies flat, directly on the upper surface 112 of the second component 106.

The lower end of the passage opening 104 in the first component 102 facing the second component 106 is widened in step-like manner and accommodates a ring-shaped elastomer sealing element 172 which extends coaxially of the screw member 122 and the sleeve base body 126 of the sleeve 123 around the lower end section of the sleeve base body 126 and the inner surface thereof rests on the outer surface 156 of the sleeve base body 126 and the outer surface thereof rests against the boundary wall of the passage opening 104 that has been widened in step-like manner.

An upper end of the ring-shaped elastomer sealing element 172 rests against a shoulder 174 at which the passage opening 104 is widened in step-like manner, whilst a lower end of the ring-shaped elastomer sealing element 172 rests against the upper surface 112 of the second component 106.

In this embodiment, the passage opening in the flange 124 of the sleeve 123 has a diameter d′ which is greater than the external diameter D of the threaded portion 132 of the screw member 122 when in the state where it is pressed against the sleeve base body 126, so that the finished sleeve 123 can easily be pulled off the screw member 122 over the threaded portion 132 of the screw member 122 in this embodiment.

Thus, in this embodiment, the sleeve 123 is not held captive on the screw member 122.

In particular, provision may be made for the diameter d′ of the passage opening 150 in the flange 124 to be of substantially the same size as the internal diameter D″ of the hollow cylindrical sleeve base body 126 when in the state where it is pressed against the sleeve base body 126, so that the flange 124 can thus only project radially outwardly, but not radially inwardly beyond the sleeve base body 126, but rather, the inside of the sleeve 123 is substantially flush with the sleeve base body 126.

This effect is achieved in that, prior to the process of pressing the flange pre-form 124′ against the sleeve base body 126, the diameter D′ of the flange pre-form 124′ is selected to be greater than was the case in the first embodiment and in particular, it is selected to be greater than the internal diameter D″ of the sleeve base body 126, namely just so large that, after the webs 144 have been bent up into the plane of the flat ring-like region 142 of the flange pre-form 124′ during the process of pressing the sleeve base body 126 against the flange pre-form 124′, the passage opening 150 in the flange 124 has the desired diameter d′ which is of substantially the same size as the internal diameter D″ of the hollow cylindrical sleeve base body 126.

In the installed state of the second embodiment of an assembly 100 such as is illustrated in FIG. 8, the sleeve base body 126 extends downwardly to the upper surface 112 of the second component 106 so that the sleeve 123 serves as a spacer between the screw member head 130 on the one hand and the second component 106 on the other.

The flange 124 of the sleeve 123 serves as a washer for the screw member 122.

In all other respects the second embodiment of a component group 100 illustrated in FIG. 8 agrees in regard to the construction, function, material and method of production as the first embodiment illustrated in FIGS. 1 to 7, so that to this extent, reference is made to the description thereof hereinabove.

1. A sleeve comprising a sleeve base body and a flange which is produced separately from the sleeve base body and protrudes in the radial direction beyond the sleeve base body,
wherein the sleeve base body has at least one projection which engages in a recess provided in the flange, wherein the sleeve base body is pressed against the flange in such a manner that the sleeve base body and the flange are connected together in captive manner.

2. A sleeve in accordance with claim 1, wherein the sleeve base body has at least two projections which engage in a respective recess provided in the flange.

3. A sleeve in accordance with claim 2, wherein the sleeve base body has at least three projections which engage in a respective recess provided in the flange.

4. A sleeve base body in accordance with claim 2, wherein the projections succeed one another substantially equidistantly around the periphery of the sleeve base body.

5. A sleeve in accordance with claim 1, wherein the at least one projection is aligned substantially parallel to the longitudinal axis of the sleeve base body.

6. A sleeve in accordance with claim 1, wherein the regions of the flange bounding the at least one recess are oriented substantially perpendicularly to the longitudinal axis of the sleeve base body in the state where it is pressed against the sleeve base body.

7. A sleeve in accordance with claim 1, wherein the at least one recess in the flange opens into a passage opening in the flange.

8. A sleeve in accordance with claim 1, wherein the flange incorporates a passage opening arranged substantially centrally of the flange.

9. A sleeve in accordance with claim 1, wherein the flange is formed from a flange pre-form wherein the regions of the flange bounding the at least one recess in the flange are oriented at an angle with respect to the central axis of the flange.

10. A sleeve in accordance with claim 9, wherein the regions of the flange pre-form bounding the at least one recess in the flange define a passage opening in the pre-form the diameter of which is greater than the diameter of the passage opening in the flange when in the state where it is pressed against the sleeve base body.

11. A sleeve in accordance with claim 1, wherein the flange protrudes radially inwardly and radially outwardly beyond the sleeve base body.

12. A sleeve in accordance with claim 1, wherein the flange protrudes only radially outwardly beyond the sleeve base body.

13. A combination of a sleeve in accordance with claim 1 and a screw member which passes through the sleeve.

14. A combination in accordance with claim 13, wherein the sleeve is held captive on the screw member.

15. A combination in accordance with claim 13, wherein the screw member comprises a screw member head, a threaded portion and a shank portion which is arranged between the screw member head and the threaded portion and has an external diameter that is smaller than the external diameter of the threaded portion, and wherein the flange incorporates a passage opening the diameter of which is smaller than the external diameter of the threaded portion of the screw member.

16. A method of making a sleeve from a sleeve base body and a flange which protrudes in the radial direction beyond the sleeve base body, comprising the following method steps:
providing a flange pre-form incorporating a passage opening in the pre-form and at least one recess;
providing a sleeve base body having at least one projection;
arranging the sleeve base body on the flange pre-form in such a manner that the at least one projection of the sleeve base body engages in the at least one recess in the flange pre-form;
pressing the sleeve base body against the flange pre-form in such a manner that the flange pre-form is deformed into a flange which is connected to the sleeve base body in captive manner.
